(19) United States
(12) Patent Application Publication
(10) Pub. No.: US 2025/0135767 A1
(43) Pub. Date: May 1, 2025

(54) A Lithographic Printing Plate Precursor

(71) Applicant: ECO3 BV, Mortsel (BE)

(72) Inventors: Thomas Billiet, Mortsel (BE); Kristof Heylen, Mortsel (BE)

(73) Assignee: ECO3 BV, Mortsel (BE)

(21) Appl. No.: 18/835,803

(22) PCT Filed: Jan. 30, 2023
(86) PCT No.: PCT/EP2023/052109

§ 371 Date: Aug. 5, 2024

(30) Foreign Application Priority Data
Feb. 7, 2022 (EP) 22155311.8

(51) Int. Cl. B41C 1/10

(52) U.S. Cl. CPC B41C 1/1016; B41C 2201/02; B41C 2201/12; B41C 2210/04; B41C 2210/08; B41C 2210/10; B41C 2210/22

(57) ABSTRACT

A lithographic printing plate precursor is disclosed which includes a support and a coating comprising a photopolymerisable layer including a polymerisable compound, an initiator and a pH sensitive colorant precursor and a protective overcoat layer provided above the photopolymerisable layer including a heat sensitive color-forming IR dye, which upon exposure to heat and/or light forms a print-out image which remains stable or increases during storage of the precursor in light or dark environment.

### TECHNICAL FIELD

The invention relates to a novel lithographic printing plate precursor.

### BACKGROUND ART

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-adhesive (ink-repelling) areas and during driographic printing, only ink is supplied to the master.

Lithographic printing masters are generally obtained by the image-wise exposure and processing of a radiation sensitive layer on a lithographic support. Imaging and processing renders the so-called lithographic printing plate precursor into a printing plate or master. Image-wise exposure of the radiation sensitive coating to heat or light, typically by means of a digitally modulated exposure device such as a laser, triggers a (physico-) chemical process, such as ablation, polymerization, insolubilization by cross-linking of a polymer or by particle coagulation of a thermoplastic polymer latex, solubilization by the destruction of intermolecular interactions or by increasing the penetrability of a development barrier layer. Although some plate precursors are capable of producing a lithographic image immediately after exposure, the most popular lithographic plate precursors require wet processing since the exposure produces a difference in solubility or difference in rate of dissolution in a developer between the exposed and the non-exposed areas of the coating. In positive working lithographic plate precursors, the exposed areas of the coating dissolve in the developer while the non-exposed areas remain resistant to the developer. In negative working lithographic plate precursors, the non-exposed areas of the coating dissolve in the developer while the exposed areas remain resistant to the developer. Most lithographic plate precursors contain a hydrophobic coating on a hydrophilic support, so that the areas which remain resistant to the developer define the ink-accepting, hence printing areas of the plate while the hydrophilic support is revealed by the dissolution of the coating in the developer at the non-printing areas.

Photopolymer printing plates rely on a working-mechanism whereby the coating-which typically includes free radically polymerisable compounds-hardens upon exposure. “Hardens” means that the coating becomes insoluble or non-dispersible in the developing solution and may be achieved through polymerization and/or crosslinking of the photosensitive coating upon exposure to light. Photopolymer plate precursors can be sensitized to blue, green or red light i.e. wavelengths ranging between 450 and 750 nm, to violet light i.e. wavelengths ranging between 350 and 450 nm or to infrared light i.e. wavelengths ranging between 750 and 1500 nm. Optionally, the exposure step is followed by a heating step to enhance or to speed-up the polymerization and/or crosslinking reaction.

In general, a top layer or protective overcoat layer over the imagable layer is required to act as an oxygen barrier to provide the desired sensitivity to the plate. A protective overcoat layer typically includes water-soluble or water-swellable polymers such as for example polyvinylalcohol. Besides acting as barrier for oxygen, the protective overcoat layer should best be easily removable during processing and be sufficiently transparent for actinic radiation, e.g. from 300 to 450 nm or from 450 to 750 nm or from 750 to 1500 nm.

The classical workflow of photopolymer plates involves first an exposure step of the photopolymer printing plate precursor in a violet or infrared platesetter, followed by an optional pre-heat step, a wash step of the protective overcoat layer, an alkaline developing step, and a rinse and gum step. Over the past years, there is a clear evolution in the direction of a simplified workflow where the pre-heat step and/or wash step are eliminated and where the processing and gumming step are carried out in one single step or where processing is carried out with a neutral gum and then gummed in a second step. Alternatively, on-press processing wherein the plate is mounted on the press and the coating layer is developed by interaction with the fountain and ink that are supplied to the plate during the press run, has become very popular. During the first runs of the press, the non-image areas are removed from the support and thereby define the non-printing areas of the plate.

In order to be able to evaluate the lithographic printing plates for image quality, such as for example image resolution and detail rendering (usually measured with an optical densitometer) before mounting them on the press, the lithographic printing plate precursors often contain a colorant such as a dye or a pigment in the coating. Such colorants provide, after processing, a contrast between the image areas containing the colorant and the hydrophilic support where the coating has been removed which enables the end-user to evaluate the image quality and/or to establish whether or not the precursor has been exposed to light. Furthermore, besides allowing for the evaluation of the image quality, a high contrast between the image and the hydrophilic support is required in order to obtain a good image registration (alignment) of the different printing plates in multi-color printing in order to ensure image sharpness (resolution) and a correct rendering of the colors in the images present.

However, a previous inspection and discrimination of the printing plate including colorants is not possible before the exposed printing plates are processed. A solution has been provided in the art for example by including components to the coating which are able to form upon exposure a so-called “print-out image”, i.e. an image which is visible before processing.

Contrast-providing colorants obtained from the so-called leuco dyes that switch color upon changes in pH, temperature, UV etc, have been widely used in the art. The leuco dye technology involves a switch between two chemical forms whereby one is substantially colorless. If the color switch is caused by for example pH or temperature, the transformation is reversible. Irreversible switches are based on redox reactions. The use of contrast-providing colorants obtained from leuco dyes that become colored in the presence of a thermal acid generator, is described for example, in U.S. Pat. Nos. 7,402,374; 7,425,406 and 7,462,440.

Thermochromic dye technology involves the design of an IR dye containing a thermocleavable group whereby a color shift is obtained upon exposure with heat and/or light. This technology offers lithographic contrast which is enhanced by increasing either the thermochromic dye concentration or the exposure energy. The heat-sensitive lithographic printing plate precursors disclosed in EP 925 916 include an IR dye which, upon IR-radiation, converts the IR-radiation into heat and at the same time changes in color. In these prior art materials, the IR dyes exhibit, beside strong absorption in the IR wavelength range, also a side-absorption in the visible wavelength range.

A problem associated with the prior art materials is that often the obtained print-out images after exposure are characterized by only a relative low contrast between the exposed and the non-exposed areas, which moreover, often fades away in time when the exposed plates are not immediately used for the printing job. In other words, the obtained contrast often decreases during handling and/or storage. As a result, it is difficult or even impossible to measure dot gain before processing and/or before printing in order to adapt the press settings in line with the obtained dot size.

In conclusion, there is still a need for photopolymer printing plate coating formulations which offer not only after, but also before the processing step a stable contrast between the image areas and non-image areas and which are designed for both direct on-press development and off press development.

### SUMMARY OF INVENTION

It is therefore an object of the present invention to provide a printing plate based on photopolymerisation which is characterized by a high image contrast between the image and non-image areas (the support) of the printing plate after processing, and at the same time an excellent print-out image upon imaging, before processing, which remains stable or even enhances during handling and/or storage.

This object is realised by the printing plate precursor defined in claim 1 with preferred embodiments defined in the dependent claims. The invention has the specific feature that the printing plate precursor includes a coating comprising a pH sensitive colorant precursor in the photopolymerisable layer and a heat sensitive color-forming IR dye in the protective overcoat layer. The heat sensitive color-forming IR dye is capable of inducing a CIE 1976 color difference ΔE1 of 2.0 or more than 2-. preferably 3 or more than 3, more preferably 4 or more than 4, most preferred 5 or more than 5-upon IR radiation and/or heating and the pH sensitive colorant precursor is capable of forming a CIE 1976 color difference ΔE2 of 12.0 or more than 12.0, more preferably of 15.0 or more than 15.0, most preferably of 18 or more than 18 upon treatment with a liquid having a pH of about 4 or below 4.

The color difference ΔE1 between the exposed (image) areas and the non-exposed (non image) areas of the coating and the color difference ΔE2 between the image areas and the support are calculated from their L*a*b* values. Upon exposure of the coating of the present invention even with a low energy density, for example between 70 and 190 mJ/m², more preferably between 75 and 150 mJ/m², most preferably between 80 and 120 mJ/m², a print-out image is formed characterised by a CIE 1976 color difference ΔE1 of 2, or more than 2.

The CIE 1976 color coordinates L*, a* and b* discussed herein are part of the well-known CIE (Commission Internationale de l'Eclairage) system of tristimulus color coordinates, which also includes the additional chroma value C* defined as C*=[(a)²+(b)²]^{1/2}. The CIE 1976 color system is described in e.g. “Colorimetry, CIE 116-1995: Industrial Color Difference Evaluation”, or in “Measuring Coloacidr” by R. W. G. Hunt, second edition, edited in 1992 by Ellis Horwood Limited, England.

CIE L*a*b* values discussed and reported herein have been measured following the ASTM E308-85 method.

It was surprisingly found that the print-out image that is formed upon heat and/or light exposure of the coating including the specific combination of the pH sensitive colorant-precursor and the heat sensitive color-forming IR dye, remains stable or is even boosted after storage, i.e. when the plate is not immediately used for processing and/or printing. Storage of the plate includes for example storage of the plate under light such as office light conditions or storage of the plate in a dark environment; storage of for example 8 hours or more after the heat- and/or light exposure step, upto one day after the heat- and/or light exposure step, and even upto several days after the heat- and/or light exposure step such as 2, 3 4 or 5 days, or one week to several two weeks.

As a result, plate linearization in order to ensure image sharpness (resolution) and a correct rendering of the colors in the images present, can already be measured conveniently on the printing plate precursor of the current invention after imaging and off-press processing instead of on printed sheets which is not only time consuming but also unfavourable in view of ink, paper and press chemicals consumption.

Other features, elements, steps, characteristics and advantages of the present invention will become more apparent from the following detailed description of preferred embodiments of the present invention. Specific embodiments of the invention are also defined in the dependent claims.

### DESCRIPTION OF EMBODIMENTS

### The Lithographic Printing Plate Precursor

The lithographic printing plate precursor according to the present invention is negative-working, i.e. after exposure and development the non-exposed areas of the coating are removed from the support and define hydrophilic (non-printing or non image) areas, whereas the exposed coating is not removed from the support and defines oleophilic (printing or image) areas. The hydrophilic areas are defined by the support which has a hydrophilic surface or is provided with a hydrophilic layer. The hydrophobic areas are defined by the coating, hardened upon exposing, optionally followed by a heating step. Areas having hydrophilic properties means areas having a higher affinity for an aqueous solution than for an oleophilic ink; areas having hydrophobic properties means areas having a higher affinity for an oleophilic ink than for an aqueous solution.

“Hardened” means that the coating becomes insoluble or non-dispersible for the developing solution and may be achieved through polymerization and/or crosslinking of the photosensitive coating upon the exposure step, optionally followed by a heating step to enhance or to speed-up the polymerization and/or crosslinking reaction. In this optional heating step, hereinafter also referred to as “pre-heat”, the plate precursor is heated, preferably at a temperature of about 80° C. to 150° C. and preferably during a dwell time of about 5 seconds to 1 minute.

The coating contains a top layer—also referred to herein as protective overcoat layer—and at least one layer including a photopolymerisable composition, said layer is also referred to as the “photopolymerisable layer”. The photopolymerisable layer has a coating thickness preferably ranging between 0.2 and 5.0 g/m², more preferably between 0.4 and 3.0 g/m², most preferably between 0.6 and 2.2 g/m².

The protective overcoat layer is provided on top of the photopolymerisable layer. The coating may further include other layers such as for example an intermediate layer, located between the support and the photopolymerisable layer and/or between the top layer and the photopolymerisable layer, an adhesion improving layer and/or other layers.

The lithographic printing plate precursor of the current invention is characterised by a strong color development in the image areas after processing with a development solution having a pH of about 4 or below 4. In addition, the lithographic printing plate precursor provides a clear print-out image immediately after the exposure step which remains substantially stable during handling and/or storage. The print-out image is visible due to the contrast of the image which is defined as the difference between the optical density at the exposed areas and the non-exposed areas.

The contrast between image (exposed) areas and non-image (non-exposed) areas is preferably as high as possible and enables the end-user to distinguish the different color selections and to inspect the quality of the image on the plate precursor for defects such as scratches, pinholes, scuff markings as well as dot gain control by measurement and subsequent adaptation of the press settings in line with the obtained dot size.

The printing plate of the present invention is characterized that it can be exposed at a low energy density, i.e. below 190 mJ/m²; preferably between 70 mJ/m² and 150 mJ/m²; more preferably between 75 mJ/m² and 120 mJ/m² and most preferably of maximum 80 mJ/m².

### Definitions

The term hydrocarbon group herein represents an optionally substituted aliphatic or aromatic hydrocarbon group. An optionally substituted aliphatic hydrocarbon group preferably represents an alkyl, cycloalkyl, alkenyl, cyclo alkenyl or alkynyl group; suitable groups thereof are described below. An optionally substituted aromatic hydrocarbon group preferably represents a hetero (aryl) group; suitable hetero (aryl) groups—i.e. suitable aryl or heteroaryl groups—are described below.

The term “alkyl” herein means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc. Examples of suitable alkyl groups are methyl, ethyl, n-propyl, isopropyl, n-butyl, 1-isobutyl, 2-isobutyl and tertiary-butyl, n-pentyl, n-hexyl, chloromethyl, trichloromethyl, iso-propyl, iso-butyl, iso-pentyl, neo-pentyl, 1-methylbutyl and iso-hexyl, 1,1-dimethyl-propyl, 2,2-dimethylpropyl and 2-methyl-butyl, cyclopropyl, cyclobutyl, cyclopentyl, cyclohexyl and methylcyclohexyl groups. Preferably, the alkyl group is a C₁ to C₆-alkyl group.

A suitable alkenyl group is preferably a C₂ to C₆-alkenyl group such as an ethenyl, n-propenyl, n-butenyl, n-pentenyl, n-hexenyl, iso-propenyl, iso-butenyl, iso-pentenyl, neo-pentenyl, 1-methylbutenyl, iso-hexenyl, cyclopentenyl, cyclohexenyl and methylcyclohexenyl group.

A suitable alkynyl group is preferably a C₂ to C₆-alkynyl group; a suitable aralkyl group is preferably a phenyl group or naphthyl group including one, two, three or more C₁ to C₆-alkyl groups;

A suitable alkaryl group is preferably a C₁ to C₆-alkyl group including an aryl group, preferably a phenyl group or naphthyl group.

A cyclic group or cyclic structure includes at least one ring structure and may be a monocyclic- or polycyclic group, meaning one or more rings fused together.

Examples of suitable aryl groups may be represented by for example an optionally substituted phenyl, benzyl, tolyl or an ortho-meta- or para-xylyl group, an optionally substituted naphtyl, anthracenyl, phenanthrenyl, and/or combinations thereof. The heteroaryl group is preferably a monocyclic or polycyclic aromatic ring comprising carbon atoms and one or more heteroatoms in the ring structure, preferably, 1 to 4 heteroatoms, independently selected from nitrogen, oxygen, selenium and sulphur. Preferred examples thereof include an optionally substituted furyl, pyridinyl, pyrimidyl, pyrazoyl, imidazoyl, oxazoyl, isoxazoyl, thienyl, tetrazoyl, thiazoyl, (1,2,3)triazoyl, (1,2,4)triazoyl, thiadiazoyl, thiofenyl group and/or combinations thereof.

Examples of an aralkyl group is preferably a phenyl or naphthyl group including one, two, three or more C₁ to C₆-alkyl groups.

Examples of an alkaryl group is preferably a C₇ to C₂₀-alkyl group including a phenyl group or naphthyl group.

Halogens are selected from fluorine, chlorine, bromine or iodine.

Suitable polyalkylene-oxide groups preferably comprise a plurality of alkylene-oxide recurring units of the formula —CnH2n-O— wherein n is preferably an integer in the range 2 to 5. Preferred alkylene-oxide recurring units are typically ethylene oxide, propylene oxide or mixtures thereof. The moiety —CnH2n- may include straight or branched chains and may also be substituted. The number of the recurring units in the polyalkylene-oxide group preferably range between 2 and 10 units, more preferably between 2 and 5 units, and preferably less than 100, more preferably less than 60.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

The optional substituents are preferably selected from hydroxy, —F, —Cl, —Br, —I, —OH, —SH, —CN, —NO₂, an alkyl group such as a methyl or ethyl group, an alkoxy group such as a methoxy or an ethoxy group, an aryloxy group, a carboxylic acid group or an alkyl ester thereof, a sulphonic acid group or an alkyl ester thereof, a phosphonic acid group or an alkyl ester thereof, a phosphoric acid group or an an ester such as an alkyl ester such as methyl ester or ethyl ester, a thioalkyl group, a thioaryl group, thioheteroaryl, —SH, a thioether such as a thioalkyl or thioaryl, ketone, aldehyde, sulfoxide, sulfone, sulfonate ester, sulphonamide, an amino, ethenyl, alkenyl, alkynyl, cycloalkyl, alkaryl, aralkyl, aryl, heteroaryl or heteroalicyclic group and/or combinations thereof.

The term print-out image is referred to as an image which becomes visible before processing after imaging.

### Toplayer or Protective Overcoat Layer

The coating includes a toplayer or protective overcoat layer which preferably acts as an oxygen barrier layer. Low molecular weight substances present in the air may deteriorate or even inhibit image formation and therefore a protective overcoat layer is applied to the coating. The protective overcoat layer should preferably be easily removable during development, adhere sufficiently to the photopolymerisable layer or optional other layers of the coating and should preferably not inhibit the transmission of light during exposure. The protective overcoat layer is provided on top of the photopolymerisable layer.

The protective overcoat layer includes a heat sensitive color-forming IR dye—i.e an infrared absorbing compound which is capable of forming a colored compound whereby a print-out image is formed upon exposure to infrared light and/or heat. The heat sensitive color-forming IR dye is preferably a thermochromic infrared absorbing dye, also referred to herein as thermochromic IR dye. The thermochromic IR dye preferably has a main absorption in the infrared wavelength range of the electromagnetic spectrum—i.e. a wavelength range between about 750 nm and 1500 nm—and does preferably not have a substantial light absorption in the visible wavelength range of the electromagnetic spectrum—i.e. a wavelength range between 390 nm and 700 nm. The heat sensitive color-forming IR dye preferably includes at least one thermocleavable group which is transformed by a chemical reaction, induced by exposure to IR radiation or heat, into a group which is a stronger electron-donor. As a result, the exposed thermochromic IR dye preferably absorbs substantially more light in the visible wavelength range of the electromagnetic spectrum, or in other words, the thermochromic IR dye preferably undergoes a hypsochromic shift whereby a visible image is formed, also referred to as print-out image. The formation of this print-out image is clearly different from a process where a compound changes from an essentially colorless compound into a pale-colored to colored compound. These compounds typically change absorption from the UV wavelength range of the electromagnetic spectrum to the visible wavelength range of the electromagnetic spectrum, i.e. these compounds typically have a batochromic shift. The contrast of the print-out image obtained by such a process is much weaker compared to the color-forming process described above of the heat sensitive color-forming IR dyes.

The contrast of the print-out image may be defined as the difference between the optical density at the exposed area and the optical density at the non-exposed area, and is preferably as high as possible.

The concentration of the thermochromic IR dyes with respect to the total dry weight of the coating, may be from 0.1% wt to 20.0% wt, more preferably from 0.5% wt to 15.0% wt, most preferred from 1.0% wt to 10.0% wt.

The heat sensitive color-forming IR dye is preferably represented by Formulae I, II or III:

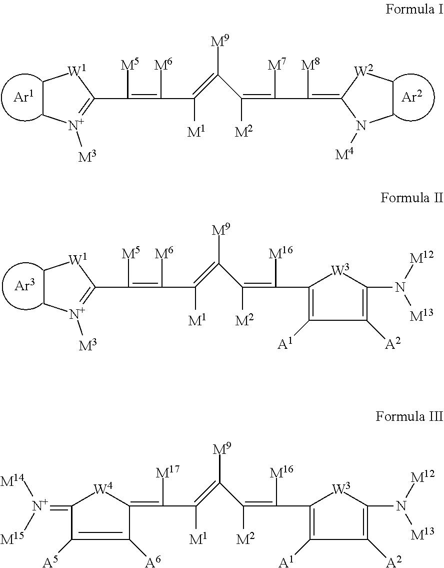

wherein
Ar¹, Ar² and Ar³ independently represent an optionally substituted aromatic hydrocarbon group or an aromatic hydrocarbon group with an annulated benzene ring which is optionally substituted,
W¹ and W² independently represent a sulphur atom, an oxygen atom, NR″ wherein R″ represents an optionally substituted alkyl group, NH, or a —CM¹⁰M¹¹ group wherein M¹⁰ and M¹¹ are independently an optionally substituted aliphatic hydrocarbon group or an optionally substituted (hetero)aryl group, or wherein M¹⁰ and M¹¹ together comprise the necessary atoms to form a cyclic structure, preferably a 5- or 6-membered ring;
W³ represent a sulphur atom or a —C(A³)═C (A⁴)-group,
W⁴ represents a sulphur atom or a —C(A⁷)═C (A⁸)-group,
M¹ and M² independently represent hydrogen, an optionally substituted aliphatic hydrocarbon group or together comprise the necessary atoms to form an optionally substituted cyclic structure, preferably M¹ and M² together comprise the necessary atoms to form an optionally substituted cyclic structure which may comprise an optionally substituted annulated benzene ring, preferably a 5- or 6-membered ring, more preferably a 5-membered ring, most preferably a 5-membered ring having a cyclic structure of 5 carbon atoms;
M³ and M⁴ independently represent an optionally substituted aliphatic hydrocarbon group;
M⁵, M⁶, M⁷ and M⁸, M¹⁶ and M¹⁷ independently represent hydrogen, a halogen or an optionally substituted aliphatic hydrocarbon group,
A¹ to A⁸ independently represent hydrogen, a halogen atom, an optionally substituted aliphatic hydrocarbon group or an optionally substituted (hetero)aryl group, or wherein each of A¹ and A², A³ and A⁴, A⁵ and A⁶, or, A⁷ and A⁸, together comprise the necessary atoms to form a cyclic structure, preferably 5- or 6-membered ring;
M¹² and M¹³ and M¹⁴ and M¹⁵ independently represent an optionally substituted aliphatic hydrocarbon group or an optionally substituted (hetero)aryl group, or wherein, two of said M¹⁴, M¹⁵, A⁵ or A⁷ together comprise the necessary atoms to form at least one cyclic structure, preferably 5- or 6-membered ring; two of said M¹², M¹³, A² or A⁴ together comprise the necessary atoms to form at least one cyclic structure preferably 5- or 6-membered ring;
M⁹ is a group which is transformed by a chemical reaction, induced by exposure to IR radiation or heat, into a group which is a stronger electron-donor than said M⁹; and said transformation provides an increase of the integrated light absorption of said dye between 350 and 700 nm;
and optionally one or more counter ions in order to obtain an electrically neutral compound.

The thermochromic IR dye can be a neutral, an anionic or a cationic dye depending on the type of the substituting groups and the number of each of the substituting groups. In a preferred embodiment, the dye of formula I, II or III comprises at least one anionic or acid group such as —CO₂H, —CONHSO₂R^{h}, —SO₂NHCORⁱ, —SO₂NHSO₂R^{j}, —PO₃H₂, —OPO₃H₂, —OSO₃H, —S—SO₃H or —SO₃H groups or their corresponding salts, wherein R^{h}, Rⁱ and R^{j} are independently an aryl or an alkyl group, preferably a methyl group, and wherein the salts are preferably alkali metal salts or ammonium salts, including mono- or di- or tri- or tetra-alkyl ammonium salts. These anionic or acid groups may be present on the aromatic hydrocarbon group or the annulated benzene ring of Ar¹, Ar² or Ar³, or on the aliphatic hydrocarbon group of M³, M⁴ or M¹² to M¹⁵, or on the (hetero)aryl group of M¹² to M¹⁵. Other substituting groups can be selected from a halogen atom, a cyano group, a sulphone group, a carbonyl group or a carboxylic ester group.

In another preferred embodiment, at least one of M³, M⁴ or M¹² to M¹⁵ is terminally substituted with at least one of these groups, more preferably with —CO₂H, —CONHSO₂—Me, —SO₂NHCO—Me, —SO₂NHSO₂—Me, —PO₃H₂ or —SO₃H groups or their corresponding salt, wherein Me represents a methyl group.

In a preferred embodiment, the heat sensitive color-forming IR dye is represented by Formulae I, II or Ill above includes M⁹ represented by one of the following groups:
(N═CR¹⁷)a-NR⁵—CO—R⁴,
—(N═CR¹⁷)b-NR⁵—SO₂—R⁶,
—(N═CR¹⁷)c-NR¹¹—SO—R¹²,
SO₂—NR¹⁵R¹⁶ and
S—CH₂—CR⁷(H)_{1-d}(R⁸)_{d}—NR⁹—COOR¹⁸,
wherein
a, b, c and d independently are 0 or 1;
R¹⁷ represents hydrogen, an optionally substituted aliphatic hydrocarbon group or an optionally substituted (hetero)aryl group, or wherein R¹⁷ and R⁵ or R¹⁷ and R¹¹ together comprise the necessary atoms to form a cyclic structure;
R⁴ represents —OR¹⁰, —NR¹³R¹⁴ or —CF³;
wherein R¹⁰ represents an optionally substituted (hetero)aryl group or an optionally branched aliphatic hydrocarbon group;
R¹³ and R¹⁴ independently represent hydrogen, an optionally substituted aliphatic hydrocarbon group or an optionally substituted (hetero)aryl group, or wherein R¹³ and R¹⁴ together comprise the necessary atoms to form a cyclic structure;
R⁶ represents an optionally substituted aliphatic hydrocarbon group or an optionally substituted (hetero)aryl group, —OR¹⁰, —NR¹³R¹⁴ or —CF³; R⁵ represents hydrogen, an optionally substituted aliphatic hydrocarbon group, a SO₃— group, a —COOR¹⁸ group or an optionally substituted (hetero)aryl group, or wherein R⁵ together with at least one of R¹⁰, R¹³ and
R¹⁴ comprise the necessary atoms to form a cyclic structure;
R¹¹, R¹⁵ and R¹⁶ independently represent hydrogen, an optionally substituted aliphatic hydrocarbon group or an optionally substituted (hetero)aryl group, or wherein R¹⁵ and R¹⁶ together comprise the necessary atoms to form a cyclic structure;
R¹² represents an optionally substituted aliphatic hydrocarbon group or an optionally substituted (hetero)aryl group;
R⁷ and R⁹ independently represent hydrogen or an optionally substituted aliphatic hydrocarbon group;
R⁸ represents —COO— or —COOR^{8′} wherein R^{8′} represents hydrogen, an alkali metal cation, an ammonium ion or a mono-, di-, tri- or tetra-alkyl ammonium ion;
R¹⁸ represents an optionally substituted (hetero)aryl group or an alpha-branched aliphatic hydrocarbon group.

Suitable examples of the heat sensitive color-forming IR dye used in the present invention are described in EP 1 910 082 pages 4 to 8, IRD-001 to IRD-101.

In a highly preferred embodiment, the heat sensitive color-forming IR dye is represented by Formula IV

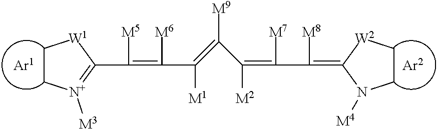

wherein Ar¹, Ar², W¹, W² and M¹ to M⁹ are as defined above.

Most preferably the heat sensitive color-forming IR dye is represented by Formula IV wherein
Ar¹ and Ar² independently represent an optionally substituted aryl group; optionally annulated with an optionally substituted benzene ring, W¹ and W² represent —C(CH₃)₂;
M¹ and M² together comprise the necessary atoms to form an optionally substituted 5-membered ring which may comprise an optionally substituted annulated benzene ring;
M³ and M⁴ independently represent an optionally substituted aliphatic hydrocarbon group,
M⁵, M⁶, M⁷ and M⁸ represent hydrogen;
M⁹ represents
—NR⁵—CO—R⁴
—NR⁵—SO₂—R⁶
—NR¹¹—SO—R¹²
SO₂—NR¹⁵R¹⁶
wherein R⁴, R⁵, R⁶, R¹¹, R¹², R¹⁵, and R¹⁶ are as defined above; and optionally one or more counter ions in order to obtain an electrically neutral compound. Preferably the IR dye comprises at least one anionic group or an acid group, such as —CO₂H, —CONHSO₂R^{h}, —SO₂NHCORⁱ, —SO₂NHSO₂R^{j}, —PO₃H₂, —OPO₃H₂, —OSO₃H, —SO₃H or —S—SO₃H groups or their corresponding salts, wherein R^{h}, Rⁱ and R^{j} are independently an aryl or an alkyl group. More preferably, at least one of the aliphatic hydrocarbon groups of M³ or M⁴ is terminally substituted with at least one of said anionic groups or acid groups.

In a highly preferred embodiment the heat sensitive color-forming IR dye is represented by Formula IV wherein
Ar¹ and Ar² independently represent an optionally substituted aryl group;
W¹ and W² represent —C(CH₃)₂;
M¹ and M² together comprise the necessary atoms to form an optionally substituted 5-membered ring which may comprise an optionally substituted annulated benzene ring;
M³ and M⁴ independently represent an optionally substituted aliphatic hydrocarbon group,
M⁵, M⁶, M⁷ and M⁸ represent hydrogen;
M⁹ represents
—NR⁵—CO—R⁴
—NR⁵—SO₂—R⁶
wherein
R⁴ is —OR¹⁰, wherein R¹⁰ is an optionally branched aliphatic hydrocarbon group;
R⁵ represents hydrogen, an optionally substituted aliphatic hydrocarbon group or an optionally substituted (hetero)aryl group,
R⁶ represents an optionally substituted aliphatic hydrocarbon group or an optionally substituted (hetero)aryl group; and
optionally one or more counter ions in order to obtain an electrically neutral compound.

Preferably, the IR dye comprises at least one anionic group or an acid group, such as —CO₂H, —CONHSO₂R^{h}, —SO₂NHCORⁱ, —SO₂NHSO₂R^{j}, —PO₃H₂, —OPO₃H₂, —OSO₃H, —SO₃H or —S—SO₃H groups or their corresponding salts, wherein R^{h}, Rⁱ and R^{j} are independently an aryl or an alkyl group. More preferably, at least one of the aliphatic hydrocarbon groups of M³ or M⁴ is terminally substituted with at least one of said anionic groups or acid groups. The salts are preferably alkali metal salts or ammonium salts, including mono- or di- or tri- or tetra-alkyl ammonium salts.

The optional counter ions in order to obtain an electrically neutral compound may be selected from for example a halogen, a sulphonate, a perfluorosulphonate, a tosylate, a tetrafluoroborate, a hexafluorophosphate, an arylborate, an arylsulphonate; or a cation such as alkali metal salts or ammonium salts, including mono- or di- or tri- or tetra-alkyl ammonium salts.

Especially preferred heat sensitive color-forming IR dyes are presented by one of the following formulae V to XII:

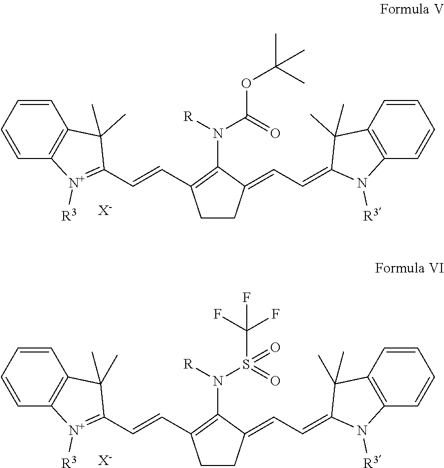

wherein
R represents hydrogen or an optionally substituted alkyl group such as for example an optionally substituted methyl, ethyl, propyl or butyl group;
X⁻ represents halogen, sulphonate, perfluorosulphonate, tosylate, tetrafluoroborate, hexafluorophosphate, arylborate or arylsulphonate; and
R³, R^{3′} independently represent an optionally substituted alkyl group, preferably a methyl or ethyl; or an ether group, preferably —CH₂—CH₂—O—CH₃;

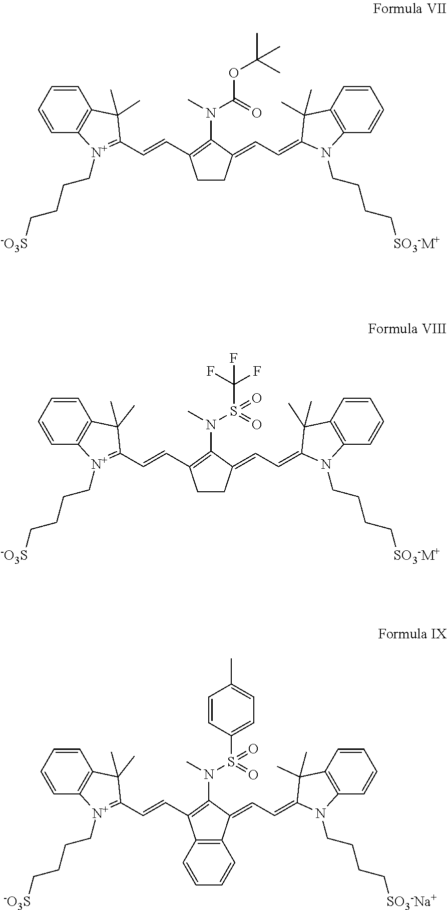

wherein
M⁺=Li⁺, Na⁺, K⁺, NH₄⁺, R′R″R′″NH⁺ wherein R′, R″, R′″ independently represent hydrogen, an optional substituted alkyl or aryl group;

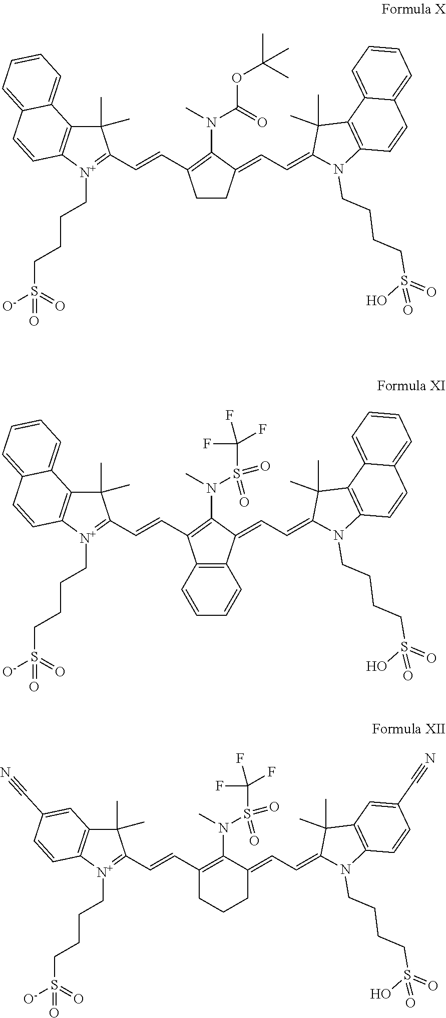 [SMILES: CN(C(=O)OC(C)(C)C)C1=C(/C=C/C2=[N+](CCCCS(=O)(=O)[O-])c3ccc4ccccc4c3C2(C)C)CC/C1=C\C=C1\N(CCCCS(=O)(=O)O)c2ccc3ccccc3c2C1(C)C ; CN(C1=C(/C=C/C2=[N+](CCCCS(=O)(=O)[O-])c3ccc4ccccc4c3C2(C)C)c2ccccc2/C1=C\C=C1\N(CCCCS(=O)(=O)O)c2ccc3ccccc3c2C1(C)C)S(=O)(=O)C(F)(F)F ; CN(C1=C(/C=C/C2=[N+](CCCCS(=O)(=O)[O-])c3ccc(C#N)cc3C2(C)C)CCC/C1=C\C=C1\N(CCCCS(=O)(=O)O)c2ccc(C#N)cc2C1(C)C)S(=O)(=O)C(F)(F)F]

The thermochromic IR dyes mentioned above may also be coupled to each other or to other IR dyes as to form IR dye dimers or oligomers. Besides a covalent coupling between two or more thermochromic IR dyes, supra-molecular complexes, comprising two or more thermochromic IR dyes, may also be formed by ionic interactions. Dimers, consisting of two different IR dyes, may be formed for example by an interaction between a cationic and an anionic IR dye, as described in e.g. WO/2004069938 and EP 1 466 728. IR dyes may also be ionically bond to a polymer as e.g. described in EP 1 582 346 wherein IR dyes, comprising two to four sulphonate groups are ionically bonded to a polymer comprising covalently attached ammonium, phosphonium, and sulphonium groups.

Supra-molecular complexes comprising two or more thermochromic IR dyes, may also be formed by hydrogen bonding or dipole-dipole interaction.

The protective overcoat layer may further include a binder. Preferred binders which can be used in the protective overcoat layer are polyvinyl alcohol. The polyvinylalcohol has preferably a hydrolysis degree ranging between 74 mol % and 99 mol %, more preferably between 80-98%. The weight average molecular weight of the polyvinylalcohol can be measured by the viscosity of an aqueous solution, 4% by weight, at 20° C. as defined in DIN 53 015, and this viscosity number ranges preferably between 2 and 26, more preferably between 2 and 15, most preferably between 2 and 10.

The protective overcoat layer may include a halogenated polymer which is preferably a hydrophobic polymer, i.e. not soluble or swellable in water at about neutral pH. This binder may be used in the protective overcoat layer in the form of a dispersion; i.e. an emulsion or suspension. The amount of the halogenated binder in the protective overcoat layer may be between 30% wt and 96% wt, more preferably between 40% wt and 90% wt and most preferably between 50% wt and 85% wt. The halogenated binder preferably includes between 60% wt and 95% wt monomeric units derived from vinylidene monomers such as vinylidene fluoride, vinylidene chloride, vinylidene bromide and/or vinylidene iodide.

The protective overcoat layer may optionally include other ingredients such as inorganic or organic acids, matting agents, surfactants such as anionic surfactants, e.g. sodium alkyl sulphate or sodium alkyl sulphonate; amphoteric surfactants, e.g. alkylaminocarboxylate and alkylamino-dicarboxylate; non-ionic surfactants, e.g. polyoxyethylene alkyl phenyl ether, (co) polymers comprising siloxane and/or perfluoroalkyl units and/or oligo (alkylene oxide) units; fillers; (organic) waxes; alkoxylated alkylene diamines as for example disclosed in EP 1 085 380 (paragraph [0021] and [0022]); glycerine; inorganic particles; pigments or wetting agents as disclosed in EP 2 916 171.

The coating thickness of the protective overcoat layer is between 0.10 and 1.75 g/m², preferably between 0.20 and 1.30 g/m², more preferably between 0.25 and 1.0 g/m² and most preferably between 0.30 and 0.80 g/m². In a more preferred embodiment of the present invention, the protective overcoat layer has a coating thickness between 0.25 and 1.75 g/m² and comprises a polyvinylalcohol having a hydrolysis degree ranging between 74 mol % and 99 mol % and a viscosity number as defined above ranging between 3 and 26.

The hydrophilic polymers in the protective overcoat layer may result in a problematic viscosity increase of press chemicals such as for example fountain solution and/or developer solution. Therefore, the thickness of the protective overcoat layer should preferably not be too high e.g. above the ranges as given above.

### Colorant Precursor

The photopolymerisable layer of the lithographic printing plate precursor comprises one or more colorant precursors. The colorant precursors are compounds which can change from substantially colorless or pale-colored to colored upon a shift in pH. The pH shift necessary for this change in color is preferably obtained upon exposure and can be enhanced by applying to the coating a liquid having a pH of about 4 or below 4, preferably in an off-press development step.

The reaction scheme can be represented by:
leuco-dye+acid→colored dye

Preferred leuco dyes which form a color upon treatment with an liquid having a pH of about 4 or below 4 and/or preferably used in combination with an acid generator include phthalide- and phthalimidine-type leuco dyes such as triarylmethane phtalides, diarylmethane phthalides, monoarylmethane phthalides, heterocyclic substituted phthalides, alkenyl substituted phthalides, bridged phthalides (e.g. spirofluorene phthalides and spirobenzanthracene phthalides) and bisphthalides; and fluoran Leuco Dyes such as fluoresceins, rhodamines and rhodols.

Especially preferred colorant precursors are leuco dyes such as heterocyclic substituted phthalides, alkenyl substituted phthalides, bridged phthalides (e.g. spirofluorene phthalides and spirobenzanthracene phthalides) and bisphthalides; and fluoran Leuco Dyes such as fluoresceins, rhodamines and rhodols.

Most preferred leuco dyes are fluoran Leuco dyes such as fluoresceins, rhodamines and rhodols.

More information about leuco dyes can be found for example in Chemistry and Applications of Leuco Dyes, Ramaiah Muthyala, Plenum Press, 1997.

The leuco dye is present in the protective overcoat layer in preferably an amount of 0.01 to 0.1 g/m², more preferably in an amount of 0.02 to 0.08 g/m², most preferably in an amount of 0.025 to 0.05 g/m².

The liquid which has a pH of about 4 or below 4 is preferably a gum solution and is described in more detail below.

The photopolymerisable layer preferably comprises an acid generator. All publicly-known photo- and thermal acid generators can be used. They can optionally be combined with a photosensitizing dye. Photo- and thermal acid generators are for example widely used in conventional photoresist material. More information can be obtained in for example “Encyclopaedia of polymer science”, 4th edition, Wiley or “Industrial Photoinitiators, A Technical Guide”, CRC Press 2010.

Preferred classes of photo- and thermal acid generators are iodonium salts, sulfonium salts, ferrocenium salts, sulfonyl oximes, halomethyl triazines, halomethylarylsulfone, α-haloacetophenones, sulfonate esters, t-butyl esters, allyl substituted phenols, t-butyl carbonates, sulfate esters, phosphate esters and phosphonate esters.

### Polymerisable Compound

The photopolymerisable layer of the lithographic printing plate precursor further includes a polymerisable compound such as a polymerisable monomer or oligomer including at least one terminal ethylenic group, hereinafter also referred to as “free-radical polymerisable monomer”. The polymerisation involves the linking together of the free-radical polymerisable monomers.

Suitable free-radical polymerisable monomers are disclosed in and of EP 2 916 171.

### The Initiator

The photopolymerisable layer of the lithographic printing plate precursor further comprises one or more photoinitiators. Any free radical initiator capable of generating free radicals upon exposure directly or in the presence of a sensitizer, is according to this invention a suitable initiator, also referred to herein as photoinitiator. Suitable examples of photoinitiators include onium salts, carbon-halogen bond-containing compounds such as [1,3,5]triazines having trihalomethyl groups, organic peroxides, aromatic ketones, thio compounds, azo based polymerization initiators, azide compounds, ketooxime esters, hexaarylbisimidazoles, metallocenes, active ester compounds, borates and quinonediazides. Of these, onium salts, especially iodonium and/or sulfonium salts are preferable in view of storage stability.

More specific suitable free-radical initiators include, for example, the derivatives of acetophenone (such as 2,2-dimethoxy-2-phenylacetophenone, and 2-methyl-I-[4-(methylthio)phenyll-2-morpholino propan-1-one); benzophenone; benzil; ketocoumarin (such as 3-benzoyl-7-methoxy coumarin and 7-methoxy coumarin); xanthone; thioxanthone; benzoin or an alkyl-substituted anthraquinone; onium salts (such as diaryliodonium hexafluoroantimonate, diaryliodonium triflate, (4-(2-hydroxytetradecyl-oxy)-phenyl)phenyliodonium hexafluoroantimonate, triarylsulfonium hexafluorophosphate, triarylsulfonium p-toluenesulfonate, (3-phenylpropan-2-onyl)triaryl phosphonium hexafluoroantimonate, and N-ethoxy (2-methyl)pyridinium hexafluorophosphate, and onium salts as described in U.S. Pat. Nos. 5,955,238, 6,037,098, and 5,629,354); borate salts (such as tetrabutylammonium triphenyl(n-butyl) borate, tetraethylammonium triphenyl(n-butyl) borate, diphenyliodonium tetraphenylborate, diphenyliodonium tetraphenylborate wherein the phenyl groups of the iodonium salt are substituted with a group including at least six carbon atoms, diphenyliodonium tetraphenylborate wherein one of the phenyl groups of the iodonium salt is substituted with a branched alkyl group including at least three carbon atoms, and triphenylsulfonium triphenyl(n-butyl) borate, and borate salts as described in U.S. Pat. Nos. 6,232,038 and 6,218,076,); haloalkyl substituted s-triazines (such as 2,4-bis(trichloromethyl)-6-(p-methoxy-styryl)-s-triazine, 2,4-bis(trichloromethyl)-6-(4-methoxy-naphth-1-yl)-s-triazine, 2,4-bis(trichloromethyl)-6-piperonyl-s-triazine, and 2,4-bis(trichloromethyl)-6-[(4-ethoxy-ethylenoxy)-phen-1-yl]-s-triazine, and s-triazines as described in U.S. Pat. Nos. 5,955,238, 6,037,098, 6,010,824 and 5,629,354); and titanocene (bis(etha.9-2,4-cyclopentadien-1-yl)bis[2,6-difluoro-3-(IH-pyrrol-1-yl)phenyl) titanium). Onium salts, borate salts, and s-triazines are preferred free radical initiators. Diaryliodonium salts and triarylsulfonium salts are preferred onium salts. Triarylalkylborate salts are preferred borate salts. Trichloromethyl substituted s-triazines are preferred s-triazines. These initiators may have optional substituents and may be used alone or in combination.

Optionally substituted trihaloalkyl sulfones wherein halo independently represents fluoro, bromo, chloro or iodo and sulfone is a chemical compound containing a sulfonyl functional group attached to two carbon atoms, are particularly preferred initiators. Tribromomethyl phenyl sulfones are most preferred photoinitiators. More details concerning this initiator can be found in WO2019/179995 paragraphs [0029] to [0040].

The amount of the photoinitiator typically ranges from 0.05 to 30% by weight, preferably from 0.1 to 15% by weight, most preferably from 0.2 to 10% by weight relative to the total dry weight of the components in the photopolymerisable composition.

A very high sensitivity can be obtained by the combination of an optical brightener as sensitizer and a polymerisation initiator.

The photopolymerisable layer may also comprise a co-initiator. Typically, a co-initiator is used in combination with a free radical initiator. Suitable co-initiators for use in the photopolymer coating are disclosed in U.S. Pat. Nos. 6,410,205; 5,049,479; EP 1 079 276, EP 1 369 232, EP 1 369 231, EP 1 341 040, US 2003/0124460, EP 1 241 002, EP 1 288 720 and in the reference book including the cited references: Chemistry & Technology UV & EB formulation for coatings, inks & paints—Volume 3—Photoinitiators for Free Radical and Cationic Polymerisation by K.K. Dietliker—Edited by P. K. T. Oldring—1991—ISBN 0 947798161. Specific co-initiators, as described in EP 107 792, may be present in the photopolymerizable layer to further increase the sensitivity. Preferred co-initiators are disclosed in EP 2 916 171 [0051].

A very high sensitivity can be obtained by including a sensitizer such as for example an optical brightener in the coating. Suitable examples of optical brighteners as sensitizers are described in WO 2005/109103 page 24, line 20 to page 39. Useful sensitizers can be selected from the sensitizing dyes disclosed in U.S. Pat. Nos. 6,410,205; 5,049,479; EP 1 079 276, EP 1 369 232, EP 1 369 231, EP 1 341 040, US 2003/0124460, EP 1 241 002 and EP 1 288 720.

Specific co-initiators, as described in EP 107 792, may be present in the photopolymerizable layer to further increase the sensitivity. Preferred co-initiators are sulfur-compounds, especially thiols like e.g. 2-mercaptobenzothiazole, 2-mercaptobenzoxazole, 2-mercapto-benzimidazole, 4-methyl-3-propyl-1,2,4-triazoline-5-thione, 4-methyl-3-n-heptyl-1,2,4-triazoline-5-thione, 4-phenyl-3-n-heptyl-1,2,4-triazoline-5-thione, 4-phenyl-3,5-dimercapto-1,2,4-triazole, 4-n-decyl-3,5-dimercapto-1,2,4-triazole, 5-phenyl-2-mercapto-1,3,4-oxadiazole, 5-methylthio-1,3,4-thiadiazoline-2-thione, 5-hexylthio-1,3,4-thiadiazoline-2-thione, mercaptophenyltetrazole, pentaerythritol mercaptopropionate, butyric acid-3-mercapto-neopentanetetrayl ester, pentaerythritol tetra(thioglycolate).

Other preferred co-initiators are polythioles as disclosed in WO 2006/048443 and WO 2006/048445. These polythiols may be used in combination with the above described thiols, e.g. 2-mercaptobenzothiazole.

The photopolymerizable layer may optionally include infrared light absorbing dyes as sensitizers absorbing light between 750 nm and 1300 nm, preferably between 780 nm and 1200 nm, more preferably between 800 nm and 1100 nm. Particular preferred sensitizers are heptamethinecyanine dyes disclosed in EP 1 359 008 paragraph [0030] to [0032].

### Other Ingredients

The photopolymerizable layer preferably includes a binder. The binder can be selected from a wide series of organic polymers. Compositions of different binders can also be used. Useful binders are described in WO2005/111727 page 17 line 21 to page 19 line 30, EP 1 043 627 in paragraph [0013] and in WO2005/029187 page 16 line 26 to page 18 line 11. Also suitable are particulate shaped polymers including homopolymers or copolymers prepared from monomers such as ethylene, styrene, vinyl chloride, methyl acrylate, ethyl acrylate, methyl methacrylate, ethyl methacrylate, acrylonitrile, vinyl carbazole, acrylate or methacrylate, or mixtures thereof.

Thermally reactive polymer fine particles including a thermally reactive group such as an ethylenically unsaturated group, a cationic polymerizable group, an isocyanate group, an epoxy group, a vinyloxy group, and a functional group having an active hydrogen atom, a carboxy group, a hydroxy group, an amino group or an acid anhydride, may be included in the coating.

The average particle diameter of the polymer fine particle is preferably 0.01 mm to 3.0 mm. Particulate polymers in the form of microcapsules, microgels or reactive microgels are suitable as disclosed in EP 1 132 200; EP 1 724 112; US 2004/106060.

The photopolymerisable layer may also comprise particles which increase the resistance of the coating against manual or mechanical damage. The particles may be inorganic particles, organic particles or fillers such as described in for example U.S. Pat. No. 7,108,956. More details of suitable spacer particles are described in EP 2 916 171 to [0056].

The photopolymerizable layer may also comprise an inhibitor. Particular inhibitors for use in the photopolymer coating are disclosed in U.S. Pat. No. 6,410,205, EP 1 288 720 and EP 1 749 240.

The photopolymerizable layer may further comprise an adhesion promoting compound. The adhesion promoting compound is a compound capable of interacting with the support, preferably a compound having an addition-polymerizable ethylenically unsaturated bond and a functional group capable of interacting with the support. Under “interacting” is understood each type of physical and/or chemical reaction or process whereby, between the functional group and the support, a bond is formed which can be a covalent bond, an ionic bond, a complex bond, a coordinate bond or a hydrogen-bond, and which can be formed by an adsorption process, a chemical reaction, an acid-base reaction, a complex-forming reaction or a reaction of a chelating group or a ligand. The adhesion promoting compounds described in EP 2 916 171 [0058] are suitable examples.

Various surfactants may be added into the photopolymerisable layer to allow or enhance the developability of the precursor; especially developing with a gum solution. Both polymeric and small molecule surfactants for example nonionic surfactants are preferred. More details are described in EP 2 916 171 [0059].

### Support

The lithographic printing plate used in the present invention comprises a support which has a hydrophilic surface or which is provided with a hydrophilic layer. The support is preferably a grained and anodized aluminium support, well known in the art. Suitable supports are for example disclosed in EP 1 843 203 (paragraphs [0066] to [0075]). The surface roughness, obtained after the graining step, is often expressed as arithmetical mean center-line roughness Ra (ISO 4287/1 or DIN 4762) and may vary between 0.05 and 1.5 μm. The aluminum support of the current invention has preferably an Ra value below 0.45 μm, more preferably below 0.40 μm and most preferably below 0.30 μm. The lower limit of the Ra value is preferably about 0.1 μm. More details concerning the preferred Ra values of the surface of the grained and anodized aluminum support are described in EP 1 356 926. By anodising the aluminum support, an Al₂O₃ layer is formed and the anodic weight (g/m² Al₂O₃ formed on the aluminum surface) varies between 1 and 8 g/m². The anodic weight is preferably ≥3 g/m², more preferably ≥3.5 g/m² and most preferably ≥4.0 g/m²

The grained and anodized aluminium support may be subjected to so-called post-anodic treatments, for example a treatment with polyvinylphosphonic acid or derivatives thereof, a treatment with polyacrylic acid, a treatment with potassium fluorozirconate or a phosphate, a treatment with an alkali metal silicate, or combinations thereof. Alternatively, the support may be treated with an adhesion promoting compound such as those described in EP 1 788 434 in [0010] and in WO 2013/182328. However, for a precursor optimized to be used without a pre-heat step it is preferred to use a grained and anodized aluminium support without any post-anodic treatment.

Besides an aluminium support, a plastic support, for example a polyester support, provided with one or more hydrophilic layers as disclosed in for example EP 1 025 992 may also be used.

The lithographic printing plate precursor can be prepared by (i) applying on a support the coating as described above and (ii) drying the precursor.

### Exposure Step

The printing plate precursor is preferably image-wise exposed by a laser emitting IR-light. Preferably, the image-wise exposing step is carried out off-press in a platesetter, i.e. an exposure apparatus suitable for image-wise exposing the precursor with a laser such as a laser diode, emitting around 830 nm or a Nd YAG laser emitting around 1060 nm, or by a conventional exposure in contact with a mask. In a preferred embodiment of the present invention, the precursor is image-wise exposed by a laser emitting IR-light.

### Preheat Step

After the exposing step, the precursor may be pre-heated in a preheating unit, preferably at a temperature of about 80° C. to 150° C. and preferably during a dwell time of about 5 seconds to 1 minute. This preheating unit may comprise a heating element, preferably an IR-lamp, an UV-lamp, heated air or a heated roll. Such a preheat step can be used for printing plate precursors comprising a photopolymerisable composition to enhance or to speed-up the polymerization and/or crosslinking reaction.

### Development Step

Subsequently to the exposing step or the preheat step, when a preheat step is present, the plate precursor may be processed (developed). Before developing the imaged precursor, a pre-rinse step might be carried out especially for the negative-working lithographic printing precursors having a protective oxygen barrier or topcoat. This pre-rinse step can be carried out in a stand-alone apparatus or by manually rinsing the imaged precursor with water or the pre-rinse step can be carried out in a washing unit that is integrated in a processor used for developing the imaged precursor. The washing liquid is preferably water, more preferably tap water. More details concerning the wash step are described in EP 1 788 434 in [0026].

During the development step, the non-exposed areas of the image-recording layer are at least partially removed without essentially removing the exposed areas. The processing liquid, also referred to as developer, can be applied to the plate e.g. by rubbing with an impregnated pad, by dipping, immersing, coating, spincoating, spraying, pouring-on, either by hand or in an automatic processing apparatus. The treatment with a processing liquid may be combined with mechanical rubbing, e.g. by a rotating brush. During the development step, any water-soluble protective layer present is preferably also removed. The development is preferably carried out at temperatures between 2° and 40° C. in automated processing units.

In a highly preferred embodiment, the processing step as described above is replaced by an on-press processing whereby the imaged precursor is mounted on a press and processed on-press by rotating said plate cylinder while feeding dampening liquid and/or ink to the coating of the precursor to remove the unexposed areas from the support. In a preferred embodiment, only dampening liquid is supplied to the plate during start-up of the press. After a number of revolutions of the plate cylinder, preferably less than 50 and most preferably less than 5 revolutions, also the ink supply is switched on. In an alternative embodiment, supply of dampening liquid and ink can be started simultaneously or only ink can be supplied during a number of revolutions before switching on the supply of dampening liquid.

The processing step may also be performed by combining embodiments described above, e.g. combining development with a processing liquid with development on-press by applying ink and/or fountain.

### Processing Liquid

Most preferably, the processing liquid is a gum solution whereby during the development step the non-exposed areas of the photopolymerisable layer are removed from the support. At the same time, the plate may be gummed; i.e. in a single step. The development with a gum solution has the additional benefit that, due to the remaining gum on the plate in the non-exposed areas, an additional gumming step to protect the surface of the support in the non-printing areas may be omitted. As a result, the precursor may be processed and gummed in one single step which involves a less complex developing apparatus than a developing apparatus comprising a developer tank, a rinsing section and a gumming section. The gumming section may comprise at least one gumming unit or may comprise two or more gumming units. These gumming units may have the configuration of a cascade system, i.e. the gum solution, used in the second gumming unit and present in the second tank, overflows from the second tank to the first tank when gum replenishing solution is added in the second gumming unit or when the gum solution in the second gumming unit is used once-only, i.e. only starting gum solution is used to develop the precursor in this second gumming unit by preferably a spraying or jetting technique. More details concerning such gum development is described in EP1 788 444. A gum solution is typically an aqueous liquid which comprises one or more surface protective compounds that are capable of protecting the lithographic image of a printing plate against contamination, e.g. by oxidation, fingerprints, fats, oils or dust, or damaging, e.g. by scratches during handling of the plate. Suitable examples of such surface protective compounds are film-forming hydrophilic polymers or surfactants. The layer that remains on the plate after treatment with the gum solution preferably comprises between 0.005 and 20 g/m² of the surface protective compound, more preferably between 0.010 and 10 g/m², most preferably between 0.020 and 5 g/m². More details concerning the surface protective compounds in the gum solution can be found in WO 2007/057348 page 9 line 3 to page 11 line 6. As the developed plate precursor is developed and gummed in one step, there is no need to post-treat the processed plate. However, after the gumming step a finishing gum may be applied.

The gum solution preferably has a pH between 1.5 and 10, more preferably between 2 and 9 and most preferably between 2.5 and 7. A suitable gum solution is described in for example EP 1 342 568 in [0008] to [0022] and WO2005/111727. In the current invention, the pH of the gum solution is preferably about 4 or below 4, more preferably 3 or below 3 and most preferably 2 or below 2. The gum solution may further comprise an inorganic salt, an anionic surfactant, a wetting agent, a chelate compound, an antiseptic compound, an anti-foaming compound and/or an ink receptivity agent and/or combinations thereof. More details about these additional ingredients are described in WO 2007/057348 page 11 line 22 to page 14 line 19.

The processing liquid may be an alkaline developer or solvent-based developer. Suitable alkaline developers have been described in US2005/0162505. An alkaline developer is an aqueous solution which has a pH of at least 11, more typically at least 12, preferably from 12 to 14.

Alkaline developers typically contain alkaline agents to obtain high pH values can be inorganic or organic alkaline agents. The developers can comprise anionic, non-ionic and amphoteric surfactants (up to 3% on the total composition weight); biocides (antimicrobial and/or antifungal agents), antifoaming agents or chelating agents (such as alkali gluconates), and thickening agents (water soluble or water dispersible polyhydroxy compounds such as glycerine or polyethylene glycol).

In the event that the processing liquid is an alkaline solution and/or has a pH of more than 4, it is required to perform an additional treatment of the processed plate with a liquid having a pH of about 4 or below 4. This liquid may comprise for example at least one non-polymeric acid or polyfunctional acid and/or their salt, such as for example compounds including carboxylic acid and/or carboxylate groups. The polyfunctional compound is preferably an aliphatic or aromatic organic polyfunctional compound. In the context of this invention non-polymeric means that the compound does not include more than two repeating units.

### Drying and Baking Step

After the processing step the plate may be dried in a drying unit. In a preferred embodiment the plate is dried by heating the plate in the drying unit which may contain at least one heating element selected from an IR-lamp, an UV-lamp, a heated metal roller or heated air.

After drying the plate can optionally be heated in a baking unit. More details concerning the heating in a baking unit can be found in WO 2007/057348 page 44 line 26 to page 45 line 20.

The printing plate thus obtained can be used for conventional, so-called wet offset printing, in which ink and an aqueous dampening liquid is supplied to the plate. Another suitable printing method uses a so-called single-fluid ink without a dampening liquid. Suitable single-fluid inks have been described in U.S. Pat. Nos. 4,045,232; 4,981,517 and 6,140,392. In a most preferred embodiment, the single-fluid ink comprises an ink phase, also called the hydrophobic or oleophilic phase, and a polyol phase as described in WO 00/32705.

### EXAMPLES

Preparation of the comparative printing plate precursors and inventive printing plate precursors.

### Preparation of the Aluminium Support S-01

A 0.3 mm thick aluminium foil was degreased by spraying with an aqueous solution containing 26 g/l NaOH at 65° C. for 2 seconds and rinsed with demineralised water for 1.5 seconds. The foil was then electrochemically grained during 10 seconds using an alternating current in an aqueous solution containing 15 g/l HCl, 15 g/l SO₄²⁻ ions and 5 g/l Al³⁺ ions at a temperature of 37° C. and a current density of about 100 A/dm². Afterwards, the aluminium foil was then desmutted by etching with an aqueous solution containing 5.5 g/l of NaOH at 36° C. for 2 seconds and rinsed with demineralised water for 2 seconds. The foil was subsequently subjected to anodic oxidation during 15 seconds in an aqueous solution containing 145 g/l of sulfuric acid at a temperature of 50° C. and a current density of 17 A/dm², then washed with demineralised water for 11 seconds and dried at 120° C. for 5 seconds.

The support thus obtained was characterized by a surface roughness Ra of 0.35-0.4 μm (measured with interferometer NT1100) and had an oxide weight of 3.0 g/m².

### Photopolymerisable Layer

The printing plate precursor PPP-01 to PPP-05, the inventive printing plates PPP-06 to PPP-17 were prepared by first coating onto the above described support S-01 the photosensitive compositions as defined in Table 1. The components were dissolved in a mixture of 35% by volume of MEK and 65% by volume of Dowanol PM (1-methoxy-2-propanol, commercially available from DOW CHEMICAL Company). The coating solution was applied at a wet coating thickness of 30 μm and then dried at 120° C. for 1 minute in a circulation oven.

TABLE 1
Composition of the photosensitive layers PL-01 to PL-08

| Ingredients | | | | | | | | |
|---|---|---|---|---|---|---|---|---|
| mg/m² | PL-01 | PL-02 | PL-03 | PL-04 | PL-05 | PL-06 | PL-07 | PL-08 |
| FST 510 (1) | 250 | 250 | 250 | 250 | 250 | 250 | 250 | 250 |
| CN 104 (2) | 250 | 250 | 250 | 250 | 250 | 250 | 250 | 250 |
| Ini-01 (3) | 60 | 60 | 60 | 60 | — | 60 | — | — |
| Ini-02 (3) | — | — | — | — | 60 | — | 60 | 60 |
| Sodium | 20 | 20 | 20 | 20 | 20 | 20 | 20 | 20 |
| tetraphenyl | | | | | | | | |
| borate | | | | | | | | |
| IR-01 (4) | 20 | 20 | 20 | 20 | 20 | 20 | 20 | 20 |
| Black XV | — | 15 | 25 | — | — | — | — | — |
| (5) | | | | | | | | |
| GN-169 (5) | 25 | — | — | — | 25 | — | — | — |
| LBC-51 (5) | — | — | — | — | — | 25 | 25 | — |
| Ruco coat | 125 | 125 | 125 | 125 | 125 | 125 | 125 | 125 |
| EC4811 (6) | | | | | | | | |
| S LEC | 125 | 125 | 125 | 125 | 125 | 125 | 125 | 125 |
| BL10 (7) | | | | | | | | |
| Tegoglide | 1.5 | 1.5 | 1.5 | 1.5 | 1.5 | 1.5 | 1.5 | 1.5 |
| 410 (8) | | | | | | | | |
| JPA 528 (9) | 130 | 130 | 130 | 130 | 130 | 130 | 130 | 130 |
| Belclene | 15 | 15 | 15 | 15 | 15 | 15 | 15 | 15 |
| 400 (10) | | | | | | | | |
| Aerosil 150 | 85 | 85 | 85 | 85 | 85 | 85 | 85 | 85 |
| (11) | | | | | | | | |

(1) FST 510 is a reaction product from 1 mole of 2,2,4-trimethylhexamethylenediisocyanate and 2 moles of hydroxyethyl-methacrylate commercially available from AZ Electronics as a 82 wt. % solution in MEK;
(2) CN 104 is an epoxy acrylate oligomer commercially available from Arkema;
(3) Ini-01 is 4-hydroxyphenyl-tribromomethyl-sulfone; Ini-02 is bis(4-t-butylphenyl) iodonium tetraphenylborate;
(4) IR-01 is an infrared absorbing dye represented by the following structure:

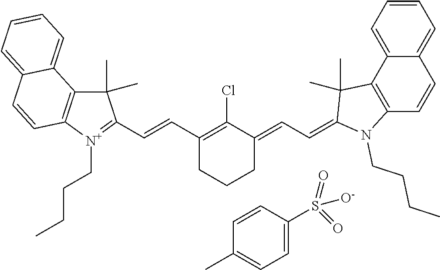

(5) Black XV is 6-diethylamino-3-methyl-2-(2,4-xylidino) fluoran and GN-169 is 3-[2,2-bis(1-ethyl-2-metghyl-1H-indol-3-yl) ethenyl]-3-[4-(diethylamino)phenyl]phtalide, both color-forming compounds commercially available from Mitsui Chemicals Europe GmbH. LBC-51 is 3-(4-dimethylamino)-3-(1-butyl-2-methyl-indol-3-yl)-6-dimethylaminophthalide is color-forming compound commercially available from Shangai Therm and Pressure sensitive Export and Import;
(6) Ruco Coat EC4811 is a non-ionic aliphatic polyether polyurethane commercially available from Rudolf GmbH;
(7) SLEC BL10 is poly(vinylbutyral-co-vinylacetate-co-vinylalcohol) commercially available from Sekisui Chemical Co., Ltd.;
(8) Tegoglide 410 is a polyether siloxane copolymer commercially available from Evonik Resource Efficiency GmbH;
(9) JPA 528 is a polyethylene glycol monomethacrylate acid phosphate commercially available from Johoku Chemical Co., Ltd.;
(10) Belciene 400 is a phosphinocarboxylic acid commercially available from BWA Water Additives UK Ltd.;
(11) Aerosil 150 is a hydrophilic fumed silica commercially available from Evonik Resource Efficiency GmbH.

### Protective Overcoat Layer

On top of the photosensitive layer, an aqueous solution with the composition as defined in Table 2 was coated (40 μm) on the printing plate precursors, and dried at 110° C. for 2 minutes.

TABLE 1
Composition of protective overcoat layers

| Ingredients | | | | | | |
|---|---|---|---|---|---|---|
| mg/m² | OC-01 | OC-02 | OC-03 | OC-04 | OC-05 | OC-06 |
| Mowiol 4-88 (1) | 309 | 309 | 309 | 80 | 80 | 80 |
| Mowiol 4-98 (2) | 186 | 186 | 186 | — | — | — |
| Mowiol 28-99 (2) | — | — | — | 80 | 80 | 80 |
| Diofan A050 (3) | — | — | — | 296 | 296 | 296 |
| Acticide LA1206 | 1 | 1 | 1 | 1 | 1 | 1 |
| (4) | | | | | | |
| Lutensol A8 (5) | 10 | 10 | 10 | 10 | 10 | 10 |
| Luviskol K30 (6) | 40 | 40 | 40 | — | — | — |
| IR-02 (7) | — | 15 | 25 | 15 | 25 | — |

(1) Mowiol 4-88TM is a partially hydrolyzed polyvinylalcohol commercially available from Kuraray;
(2) Mowiol 4-98TM and Mowiol 28-99 are fully hydrolyzed polyvinylalcohols commercially available from Kuraray;
(3) Diofan A050 is a polyvinylidene chloride latex commercially available from Solvay;
(4) Acticide LA1206TM is a biocide commercially available from Thor;
(5) Lutensol A8TM is a surface active agent commercially available from BASF;
(6) Luviskol K30TM is a polyvinylpyrolidone homopolymer commercially available from BASF;
(7) IR-02 is an infrared absorbing dye having the following formula:

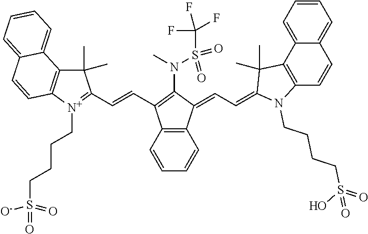 [SMILES: CN(C1=C(/C=C/C2=[N+](CCCCS(=O)(=O)[O-])c3ccc4ccccc4c3C2(C)C)c2ccccc2/C1=C\C=C1\N(CCCCS(=O)(=O)O)c2ccc3ccccc3c2C1(C)C)S(=O)(=O)C(F)(F)F]

### Imaging

The obtained printing plate precursors PPP-01 to PPP-17 were imaged at 2400 dpi with a High Power Creo 40W TE38 thermal platesetter TM (200 Ipi Agfa Balanced Screening (ABS)), commercially available from Kodak and equipped with a 830 nm IR laser diode, at energy densities of 130 mJ/cm2.

### Results

### ΔE Measurement

Lab measurement executed with a GretagMacBeth SpectroEye reflection spectrophotometer with the settings: D50 (illuminant), 2° (Observer), No filter; commercially available from GretagMacBeth. The total color difference ΔE is a single value that takes into account the difference between the L, a and b* values of the image areas and the non-image areas:

$$Δ E = \sqrt{Δ {L}^{2} + Δ {a}^{2} + Δ {b}^{2}}$$

The higher the total color difference ΔE, the better the obtained contrast. The color difference between the exposed and non-exposed areas is defined herein as ΔE1 and the color difference between the image areas after processing and the support is defined herein as ΔE2.

### Stability of the Print-Out Image

The stability of the print-out image (obtained after the exposure step described above) of the printing plate precursors PPP-01 to PPP-17 was evaluated by determining the total color difference ΔE1 before and after exposing the printing plate precursors for 8 hours to regular white office light (800 lux) and after storing the printing plate for 40 hours in dark conditions. The results of the obtained ΔE1 measurements are summarised in Tables 3, 4 and 5 below.

TABLE 3
Results of ΔE1 obtained for the comparative
printing plate precursors PPP-01 to PPP-05

| Printing | | Color- | | ΔE1* | | | | |
|---|---|---|---|---|---|---|---|---|
| Plate | Photo | forming | Overcoat | Out of | Dark | | Light | |
| Precursor | layer | agent | No dye | engine | storage** | | storage** | |
| PPP-01 | PL-01 | GN-169 | OC-01 | 5.4 | 2.7 | −50% | 7.0 | +30% |
| PPP-02 | PL-05 | GN-169 | OC-01 | 6.5 | 4.8 | −26% | 1.05 | −84% |
| PPP-03 | PL-06 | LBC-51 | OC-01 | 3.9 | 0.3 | −92% | 3.1 | −20% |
| PPP-04 | PL-07 | LBC-51 | OC-01 | 7.7 | 5.4 | −30% | 0.5 | −93% |
| PPP-05 | PL-03 | Black | OC-06 | 3.4 | 1.1 | −68% | 3.8 | +12% |
| | | XV | | | | | | |

*ΔE1: color difference between the exposed and non-exposed areas;
**see above.

TABLE 4
Results of ΔE1 obtained for the inventive
printing plate precursors PPP-06 to PPP-15

| | | | Protective | | | | | |
|---|---|---|---|---|---|---|---|---|
| Printing | | Color- | overcoat | ΔE1* | | | | |
| Plate | Photo | forming | layer | Out of | Dark | | Light | |
| Precursor | layer | agent | IR dye | engine | storage** | | storage** | |
| PPP-06 | PL-01 | GN-169 | OC-02 | 4.5 | 3.4 | −24% | 6.8 | +51% |
| PPP-07 | PL-01 | GN-169 | OC-03 | 4.6 | 3.9 | −15% | 6.8 | +48% |
| PPP-08 | PL-01 | GN-169 | OC-05 | 5.7 | 5.5 | −4% | 3.1 | +14% |
| PPP-09 | PL-02 | Black | OC-04 | 3.7 | 3.4 | −6% | 4.2 | +15% |
| | | XV | | | | | | |
| PPP-10 | PL-02 | Black | OC-05 | 7.3 | 6.5 | −11% | 8.8 | +21% |
| | | XV | | | | | | |
| PPP-11 | PL-03 | Black | OC-04 | 4.5 | 4.5 | — | 6.9 | +53% |
| | | XV | | | | | | |
| PPP-12 | PL-03 | Black | OC-05 | 7.8 | 7.2 | −8% | 11.2 | +44% |
| | | XV | | | | | | |
| PPP-13 | PL-07 | LBC-51 | OC-03 | 11.6 | 9.5 | −18% | 9.7 | −16% |
| PPP-14 | PL-07 | LBC-51 | OC-04 | 9.6 | 7.2 | −25% | 7.2 | −25% |
| PPP-15 | PL-07 | LBC-51 | OC-05 | 13.3 | 10.8 | −19% | 11.1 | −17% |

*ΔE1: color difference between the exposed and non-exposed areas;
**see above.

TABLE 5
Results of ΔE1 obtained for the comparative
printing plate precursors PPP-16 and PPP-17

| | | | Protective | | | | | |
|---|---|---|---|---|---|---|---|---|
| Printing | | Color- | overcoat | ΔE1* | | | | |
| Plate | Photo | forming | layer | Out of | Dark | | Light | |
| Precursor | layer | agent | IR dye | engine | storage** | | storage** | |
| PPP-16 | PL-08 | / | OC-03 | 7.5 | 7.8 | −+4% | 7.7 | +3% |
| PPP-17 | PL-04 | / | OC-05 | 6.4 | 6.5 | −+2% | 6.5 | −+1% |

*ΔE1: color difference between the exposed and non-exposed areas;
**see above.

The results summarized in Tables 3 to 5 show that ΔE1 of the comparative printing plates PP-01 to PP-05 decreases for 50% or more after 40 h in a dark environment (comparative printing plates PP-01, PP-03 and PP-05) and/or after 8 h exposure in office light (comparative printing plates PP-02 and PP-04); and ΔE1 of the inventive printing plates PP-06 to PP-015 only decreases for 25% or less after 40 h in a dark environment;

### Off-Press Processing

After the exposure step, the printing plate precursors PPP-01 to PPP-17 were subjected to a manual wash-out of the non-image areas with an acid liquid. The acid liquid used was RC795A, a storage gum commercially available from Agfa having a pH of 1.6.

Subsequently, the total color difference ΔE2 between the image areas and the support was determined and the results are summarised in Table 6, 7 and 8 below.

TABLE 6
Results of ΔE2 obtained for the comparative
printing plates PP-01 to PP-05

| | | Color- | Protective | |
|---|---|---|---|---|
| | Photo | forming | overcoat layer | ΔE2* |
| Printing Plate | layer | agent | No dye | Acid dev |
| PP-01 | PL-01 | GN-169 | OC-01 | 19 |
| PP-02 | PL-05 | GN-169 | OC-01 | 18 |
| PP-03 | PL-06 | LBC-51 | OC-01 | 24 |
| PP-04 | PL-07 | LBC-51 | OC-01 | 23 |
| PP-05 | PL-03 | Black XV | OC-06 | 22 |

*ΔE2: color difference between the image areas after processing and the support.

TABLE 7
Results of ΔE2 obtained for the inventive
printing plates PP-06 to PP-15

| | | | Protective | |
|---|---|---|---|---|
| | | Color- | overcoat | |
| Printing | Photo | forming | layer | ΔE2* |
| Plate | layer | agent | IR dye | Acid Dev |
| PP-06 | PL-01 | GN-169 | OC-02 | 18 |
| PP-07 | PL-01 | GN-169 | OC-03 | 19 |
| PP-08 | PL-01 | GN-169 | OC-05 | 18 |
| PP-09 | PL-02 | Black XV | OC-04 | 15 |
| PP-10 | PL-02 | Black XV | OC-05 | 16 |
| PP-11 | PL-03 | Black XV | OC-04 | 26 |
| PP-12 | PL-03 | Black XV | OC-05 | 26 |
| PP-13 | PL-07 | LBC-51 | OC-03 | 25 |
| PP-14 | PL-07 | LBC-51 | OC-04 | 25 |
| PP-15 | PL-07 | LBC-51 | OC-05 | 27 |

*ΔE2: color difference between the image areas after processing and the support.

TABLE 8
Results of ΔE2 obtained for the
comparative printing plates PP-16 and

| | | | Protective | |
|---|---|---|---|---|
| | | Color- | overcoat | |
| Printing | Photo | forming | layer | ΔE2* |
| Plate | layer | agent | IR dye | Acid dev |
| PP-16 | PL-08 | / | OC-03 | 5 |
| PP-17 | PL-04 | / | OC-05 | 5 |

*ΔE2: color difference between the image areas after processing and the support.

The results in Tables 6 to 8 show that ΔE2—the color difference between image areas and the support—is at least 15 for all the printing plates PP-01 to PP-15 including a pH sensitive color-forming agent in the photolayer.

The comparative printing plates PP-16 and PP-17 including no pH sensitive color-forming agent in the photolayer have a ΔE2 value of only 5.

1. A negative-working lithographic printing plate precursor including a support and a coating comprising a photopolymerisable layer including a polymerisable compound and a photoinitiator, and a protective overcoat layer provided above the photopolymerisable layer:
characterized in that the photopolymerisable layer includes a pH sensitive colorant precursor capable of forming a CIE 1976 color difference ΔE2 of 12.0 or more than 12.0 upon treatment with a liquid having a pH of about 4 or below 4 and that the protective overcoat layer includes a heat sensitive color-forming IR dye capable of inducing a CIE 1976 color difference ΔE1 of 2.0 or more than 2 upon heating and/or IR radiation.

2. The printing plate precursor according to claim 1, wherein the heat sensitive color-forming IR dye includes a thermocleavable group which transforms into a group which is a stronger electron-donor upon exposure to heat and/or IR radiation.

3. The printing plate precursor according to claim 1, wherein the heat sensitive color-forming IR dye is an infrared absorbing dye which has a main absorption in the infrared wavelength range of the electromagnetic spectrum before exposure to heat and/or IR radiation, and absorbs substantially more light in the visible wavelength range of the electromagnetic spectrum after exposure to heat and/or IR radiation.

4. The printing plate precursor according to claim 1, wherein the heat sensitive color-forming IR dye is represented by Formula IV 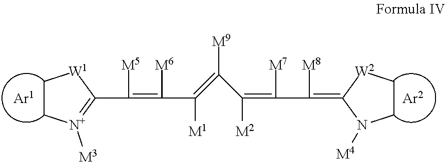
wherein
Ar¹ and Ar² independently represent an optionally substituted aromatic hydrocarbon group or an aromatic hydrocarbon group with an annulated benzene ring which is optionally substituted;
W¹ and W² independently represent a sulphur atom, an oxygen atom, NR″ wherein R″ represents an optionally substituted alkyl group, NH, or a —CM¹⁰M¹¹ group wherein M¹⁰ and M¹¹ are independently an optionally substituted aliphatic hydrocarbon group or an optionally substituted (hetero)aryl group, or wherein M¹⁰ and M¹¹ together comprise the necessary atoms to form a cyclic structure;
M³ and M⁴ independently represent an optionally substituted aliphatic hydrocarbon group;
M⁵, M⁶, M⁷ and M⁸ independently represent hydrogen, a halogen or an optionally substituted aliphatic hydrocarbon group,
M¹ and M² together comprise the necessary atoms to form an optionally substituted 5-membered ring which may comprise an optionally substituted annulated benzene ring;
M⁹ represents —(N═CR¹⁷)a-NR⁵—CO—R⁴, —(N═CR¹⁷)b-NR⁵—SO₂—R⁶, —(N═CR¹⁷)c-NR¹¹—SO—R¹², —SO₂—NR¹⁵R¹⁶ or —S—CH₂—CR⁷(H)_{1-d}(R⁸)_{d}—NR⁹—COOR¹⁸,
wherein
a, b, c and d independently are 0 or 1;
R¹⁷ represents hydrogen, an optionally substituted aliphatic hydrocarbon group or an optionally substituted (hetero)aryl group, or wherein R¹⁷ and R⁵ or R¹⁷ and R¹¹ together comprise the necessary atoms to form a cyclic structure;
R⁴ represents —OR¹⁰, —NR¹³R¹⁴ or —CF₃;
wherein R¹⁰ represents an optionally substituted (hetero)aryl group or an optionally branched aliphatic hydrocarbon group;
R¹³ and R¹⁴ independently represent hydrogen, an optionally substituted aliphatic hydrocarbon group or an optionally substituted (hetero)aryl group, or wherein R¹³ and R¹⁴ together comprise the necessary atoms to form a cyclic structure;
R⁶ represents an optionally substituted aliphatic hydrocarbon group or an optionally substituted (hetero)aryl group, —OR¹⁰, —NR¹³R¹⁴ or —CF₃;
R⁵ represents hydrogen, an optionally substituted aliphatic hydrocarbon group, a SO₃-group, a —COOR¹⁸ group or an optionally substituted (hetero)aryl group, or wherein R⁵ together with at least one of R¹⁰, R¹³ and R¹⁴ comprise the necessary atoms to form a cyclic structure;
R¹¹, R¹⁵ and R¹⁶ independently represent hydrogen, an optionally substituted aliphatic hydrocarbon group or an optionally substituted (hetero)aryl group, or wherein R¹⁵ and R¹⁶ together comprise the necessary atoms to form a cyclic structure;
R¹² represents an optionally substituted aliphatic hydrocarbon group or an optionally substituted (hetero)aryl group;
R⁷ and R⁹ independently represent hydrogen or an optionally substituted aliphatic hydrocarbon group; and
R⁸ represents —COO— or —COOR^{8′} wherein R^{8′} represents hydrogen, an alkali metal cation, an ammonium ion or a mono-, di-, tri- or tetra-alkyl ammonium ion.

5. The printing plate precursor according to claim 1, wherein the pH sensitive colorant precursor is selected from phthalide- and phthalimidine-type leuco dyes, and fluoran Leuco dyes.

6. The printing plate precursor according to claim 1, wherein the photopolymerisable layer further comprises an acid generator.

7. The printing plate precursor according to claim 1, wherein the photoinitiator is selected from an optionally substituted trihaloalkyl sulfone or an onium salt.

8. A method for making a negative-working lithographic printing plate precursor comprising the steps of:
applying the coating as defined in claim 1 on a support, and
drying the precursor.

9. A method for making a negative-working lithographic printing plate comprising the steps of:
image-wise exposing the lithographic printing plate precursor as defined in claim 1,
optionally subjecting the lithographic plate precursor to heat; and
developing the exposed printing plate precursor with a liquid which has a pH of about 4 or below 4 thereby removing the coating from the support in the non-image areas.

10. A method for making a negative-working lithographic printing plate comprising the steps of:
image-wise exposing a lithographic printing plate as defined in claim 1;
optionally subjecting the lithographic plate precursor to heat; and
developing the plate precursor by mounting the precursor on a plate cylinder of a lithographic printing press and rotating the plate cylinder while feeding dampening liquid and/or ink to the precursor thereby removing the non-exposed areas of the coating from the support.

11. The printing plate precursor according to claim 2, wherein the heat sensitive color-forming IR dye is an infrared absorbing dye which has a main absorption in the infrared wavelength range of the electromagnetic spectrum before exposure to heat and/or IR radiation, and absorbs substantially more light in the visible wavelength range of the electromagnetic spectrum after exposure to heat and/or IR radiation.

12. The printing plate precursor according to claim 11, wherein the heat sensitive color-forming IR dye is represented by Formula IV 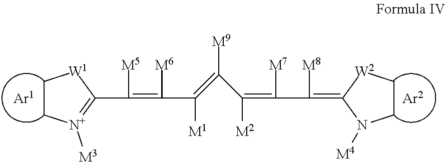
wherein
Ar¹ and Ar² independently represent an optionally substituted aromatic hydrocarbon group or an aromatic hydrocarbon group with an annulated benzene ring which is optionally substituted;
W¹ and W² independently represent a sulphur atom, an oxygen atom, NR″ wherein R″ represents an optionally substituted alkyl group, NH, or a —CM¹⁰M¹¹ group wherein M¹⁰ and M¹¹ are independently an optionally substituted aliphatic hydrocarbon group or an optionally substituted (hetero)aryl group, or wherein M¹⁰ and M¹¹ together comprise the necessary atoms to form a cyclic structure;
M³ and M⁴ independently represent an optionally substituted aliphatic hydrocarbon group;
M⁵, M⁶, M⁷ and M⁸ independently represent hydrogen, a halogen or an optionally substituted aliphatic hydrocarbon group,
M¹ and M² together comprise the necessary atoms to form an optionally substituted 5-membered ring which may comprise an optionally substituted annulated benzene ring;
M⁹ represents —(N═CR¹⁷)a-NR⁵—CO—R⁴, —(N═CR¹⁷)b-NR⁵—SO₂—R⁶, —(N═CR¹⁷)c-NR¹¹—SO—R¹², —SO₂—NR¹⁵R¹⁶ or —S—CH₂—CR⁷(H)_{1-d}(R⁸)_{d}—NR⁹—COOR¹⁸,
wherein
a, b, c and d independently are 0 or 1;
R¹⁷ represents hydrogen, an optionally substituted aliphatic hydrocarbon group or an optionally substituted (hetero)aryl group, or wherein R¹⁷ and R⁵ or R¹⁷ and R¹¹ together comprise the necessary atoms to form a cyclic structure;
R⁴ represents —OR¹⁰, —NR¹³R¹⁴ or —CF₃;
wherein R¹⁰ represents an optionally substituted (hetero)aryl group or an optionally branched aliphatic hydrocarbon group;
R¹³ and R¹⁴ independently represent hydrogen, an optionally substituted aliphatic hydrocarbon group or an optionally substituted (hetero)aryl group, or wherein R¹³ and R¹⁴ together comprise the necessary atoms to form a cyclic structure;
R⁶ represents an optionally substituted aliphatic hydrocarbon group or an optionally substituted (hetero)aryl group, —OR¹⁰, —NR¹³R¹⁴ or —CF₃;
R⁵ represents hydrogen, an optionally substituted aliphatic hydrocarbon group, a SO₃-group, a —COOR¹⁸ group or an optionally substituted (hetero)aryl group, or wherein R⁵ together with at least one of R¹⁰, R¹³ and R¹⁴ comprise the necessary atoms to form a cyclic structure;
R¹¹, R¹⁵ and R¹⁶ independently represent hydrogen, an optionally substituted aliphatic hydrocarbon group or an optionally substituted (hetero)aryl group, or wherein R¹⁵ and R¹⁶ together comprise the necessary atoms to form a cyclic structure;
R¹² represents an optionally substituted aliphatic hydrocarbon group or an optionally substituted (hetero)aryl group;
R⁷ and R⁹ independently represent hydrogen or an optionally substituted aliphatic hydrocarbon group; and
R⁸ represents —COO— or —COOR^{8′} wherein R^{8′} represents hydrogen, an alkali metal cation, an ammonium ion or a mono-, di-, tri- or tetra-alkyl ammonium ion.

13. The printing plate precursor according to claim 12, wherein the pH sensitive colorant precursor is selected from phthalide- and phthalimidine-type leuco dyes, and fluoran Leuco dyes.

14. The printing plate precursor according to claim 13, wherein the photopolymerisable layer further comprises an acid generator.

15. The printing plate precursor according to claim 14, wherein the photoinitiator is selected from an optionally substituted trihaloalkyl sulfone or an onium salt.

16. A method for making a negative-working lithographic printing plate precursor comprising the steps of:
applying the coating as defined in claim 15 on a support, and
drying the precursor.

17. A method for making a negative-working lithographic printing plate comprising the steps of:
image-wise exposing the lithographic printing plate precursor as defined in claim 15,
optionally subjecting the lithographic plate precursor to heat; and
developing the exposed printing plate precursor with a liquid which has a pH of about 4 or below 4 thereby removing the coating from the support in the non-image areas.

18. A method for making a negative-working lithographic printing plate comprising the steps of:
image-wise exposing a lithographic printing plate as defined in claim 15;
optionally subjecting the lithographic plate precursor to heat; and
developing the plate precursor by mounting the precursor on a plate cylinder of a lithographic printing press and rotating the plate cylinder while feeding dampening liquid and/or ink to the precursor thereby removing the non-exposed areas of the coating from the support.
